(19) United States
(12) Patent Application Publication
(10) Pub. No.: US 2017/0289000 A1
(43) Pub. Date: Oct. 5, 2017

(54) SYSTEMS AND METHODS FOR CONTROLLING PROCESSING PERFORMANCE

(71) Applicant: QUALCOMM Incorporated, San Diego, CA (US)

(72) Inventors: Hee Jun Park, San Diego, CA (US); Rohit Nambyar, San Diego, CA (US)

(21) Appl. No.: 15/086,842

(22) Filed: Mar. 31, 2016

(51) Int. Cl. H04L 12/26

(52) U.S. Cl. CPC H04L 43/0864; H04L 43/04

(57) ABSTRACT

A method for controlling processing performance by an electronic device is described. The method includes determining a processing performance requirement based on a time difference between a response requirement based on an application type and a network delay. The method also includes determining a processing performance mode based on the processing performance requirement and a processing efficiency profile. The method further comprises operating a processor based on the processing performance mode.

### FIELD OF DISCLOSURE

The present disclosure relates generally to electronic devices. More specifically, the present disclosure relates to systems and methods for controlling processing performance.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices communicate with a network. For example, a smartphone may communicate with a remote electronic device over a network. It may be difficult to ensure a good user experience with an electronic device that communicates with a network. For example, network latency can be highly variable, which can impact the quality of the end user experience. As can be observed from this discussion, systems and methods that improve electronic device end user experience may be beneficial.

### SUMMARY

A method for controlling processing performance by an electronic device is described. The method includes determining a processing performance requirement based on a time difference between a response requirement based on an application type and a network delay. The method also includes determining a processing performance mode based on the processing performance requirement and a processing efficiency profile. The method further includes operating a processor based on the processing performance mode.

The method may include determining the network delay by measuring a time between a request time and a response time. The network delay may include a network transit time and a server processing time.

Determining the processing performance mode may include determining one or more processing performance modes with one or more respective processing performance times that are less than or equal to the processing performance requirement. Determining the processing performance mode may also include determining a most efficient processing performance mode of the one or more processing performance modes by selecting, from the one or more processing performance modes, a processing performance mode corresponding to a highest associated processing efficiency indicated by the processing efficiency profile. Determining the processing performance mode may include determining a minimum processor operating frequency that satisfies the processing performance requirement.

The method may include determining the processing efficiency profile by determining a set of processing energy efficiencies corresponding to a set of processing performance modes. The method may include determining the response requirement by analyzing one or more usage metrics.

An electronic device for controlling processing performance is also described. The electronic device includes a processor. The processor is configured to determine a processing performance requirement based on a time difference between a response requirement based on an application type and a network delay. The processor is also configured to determine a processing performance mode based on the processing performance requirement and a processing efficiency profile. The processor is further configured to operate the processor based on the processing performance mode.

A computer-program product for controlling processing performance is also described. The computer-program product includes a non-transitory computer-readable medium with instructions. The instructions include code for causing the electronic device to determine a processing performance requirement based on a time difference between a response requirement based on an application type and a network delay. The instructions also include code for causing the electronic device to determine a processing performance mode based on the processing performance requirement and a processing efficiency profile. The instructions further include code for causing the electronic device to operate a processor based on the processing performance mode.

### BRIEF DESCRIPTION OF THE DRAWINGS

FIG. 1 is a block diagram illustrating one example of an electronic device in which systems and methods for controlling processing performance may be implemented;

FIG. 2 is a flow diagram illustrating one configuration of a method for controlling processor performance;

FIG. 3 includes a block diagram illustrating an example of network communication;

FIG. 4 is a block diagram illustrating examples of components or elements that may be implemented in an electronic device for controlling processing performance;

FIG. 5 is a diagram illustrating an example of determining a processing performance mode in accordance with the systems and methods disclosed herein;

FIG. 6 is a graph illustrating an example of user experience over total response time;

FIG. 7 includes graphs that illustrate examples of processor power consumption and energy efficiency;

FIG. 8 includes a graph illustrating examples of page load times versus processor energy consumption for multiple processors;

FIG. 9 is a block diagram illustrating an example of hierarchy layers in which systems and methods for controlling processing performance may be implemented;

FIG. 10 is a flow diagram illustrating a more specific configuration of a method for controlling processor performance; and

FIG. 11 illustrates certain components that may be included within an electronic device configured to implement various configurations of the systems and methods disclosed herein.

### DETAILED DESCRIPTION

The systems and methods disclosed herein may relate to controlling processing performance. For example, some configurations of the systems and methods disclosed herein may include adjusting client processing performance in network (e.g., user-network) interactive applications (e.g., web browsing) based on network latency. In applications that utilize both network communication and client processing (e.g., web browsing, messaging, short message service (SMS), simple notification service (SNS), network gaming, etc.), user experience may be a function of total response time. Total response time may include a sum of client processing time, network transit time (e.g., network overhead time) and server processing time. Network transit time (e.g., network overhead time) and server processing time may be unpredictable and may not be controlled by the client.

In some approaches, a client processing performance policy (e.g., dynamic clock and voltage scaling (DCVS)) and/or big.LITTLE processor scheduler (e.g., central processing unit (CPU) scheduler) may be tuned and/or optimized for a few lab test cases to meet the latency time threshold and power consumption target for the few test cases. In reality, however, there may be a wide variation in network round trip delays. The wide variation may be due to server location, the number of servers that content (e.g., webpage content) is distributed on and/or connectivity signal strength. Accordingly, some problems that may impact user experience may include using a “static” processing performance policy (e.g., DCVS or big.LITTLE CPU scheduler) that is tuned and/or optimized for a few lab test cases regardless of real-world variation and changes in network overhead time and/or regardless of each user's difference preference on battery life or total response time.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

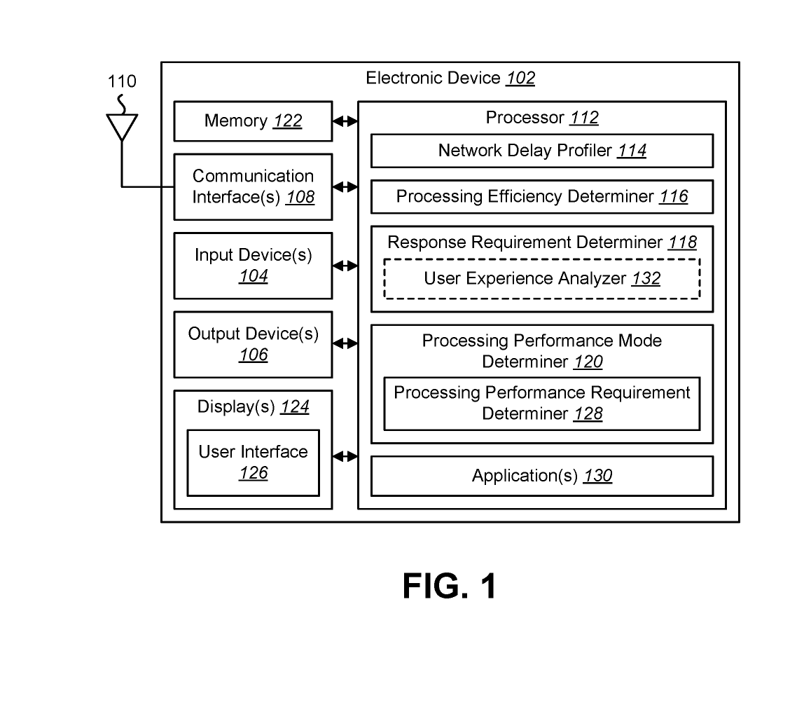

FIG. 1 is a block diagram illustrating one example of an electronic device 102 in which systems and methods for controlling processing performance may be implemented. Examples of the electronic device 102 include cellular phones, smart phones, user equipments (UEs), client devices, computers (e.g., desktop computers, laptop computers, etc.), tablet devices, media players, gaming consoles, televisions, vehicles, automobiles, cameras, video camcorders, digital cameras, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart appliances, healthcare equipment, personal digital assistants (PDAs), set-top boxes, appliances, etc. In some configurations, the electronic device 102 may be a “client” in a client-server relationship in a network context.

The electronic device 102 may include one or more components or elements. One or more of the components or elements may be implemented in hardware (e.g., circuitry) or a combination of hardware and software and/or firmware (e.g., a processor with instructions).

In some configurations, the electronic device 102 may perform one or more of the functions, procedures, methods, steps, etc., described in connection with one or more of FIGS. 1-10. Additionally or alternatively, the electronic device 102 may include one or more of the structures described in connection with one or more of FIGS. 1-10.

In some configurations, the electronic device 102 may include a processor 112, a memory 122, a display 124, one or more input devices 104, one or more output devices 106, and/or one or more communication interfaces 108. The processor 112 may be coupled to (e.g., in electronic communication with) the memory 122, display 124, input device(s) 104, output device(s) 106, and/or communication interface(s) 108. It should be noted that one or more of the elements of the electronic device 102 described in connection with FIG. 1 (e.g., input device(s) 104, output device(s) 106, display(s) 124, etc.) may be optional and/or may not be included (e.g., implemented) in the electronic device 102 in some configurations.

The processor 112 may be a general-purpose single- or multi-chip microprocessor (e.g., an Advanced Reduced Instruction Set Computing (RISC) Machine (ARM)), a special-purpose microprocessor (e.g., a digital signal processor (DSP)), a microcontroller, a programmable gate array, etc. The processor 112 may be referred to as a central processing unit (CPU). Although just a single processor 112 is shown in the electronic device 102, in an alternative configuration, a combination of processors (e.g., one or more application processors, ARMs and/or digital signal processors (DSPs), etc.) could be used. The processor 112 may be configured to implement one or more of the methods disclosed herein. The processor 112 may include and/or implement a network delay profiler 114, a processing efficiency determiner 116, a response requirement determiner 118, a processing performance mode determiner 120, one or more applications 130 and/or a user experience analyzer 132 in some configurations. The application(s) 130 may be one or more programs executed by the electronic device 102 (e.g., processor(s) 112). Examples of application(s) 130 include web browser(s), game(s) (e.g., network game(s), online game(s), etc.), remote controller(s) (e.g., drone controller(s), car controller(s), robot controller(s), remote surgery controller(s), automated home controller(s), game controller(s), etc.), instant messaging application(s), text messaging application(s), email application(s), mapping application(s), navigation application(s), social networking application(s), audio streaming application(s), video streaming application(s), calling application(s), video conferencing application(s), health monitoring application(s), commerce application(s), scheduling application(s) (e.g., calendar application(s), reminder application(s), etc.), productivity application(s), etc.

The memory 122 may be any electronic component capable of storing electronic information. For example, the memory 122 may be implemented as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

The memory 122 may store instructions and/or data. The processor 112 may access (e.g., read from and/or write to) the memory 122. The instructions may be executable by the processor 112 to implement one or more of the methods described herein. Executing the instructions may involve the use of the data that is stored in the memory 122. When the processor 112 executes the instructions, various portions of the instructions may be loaded onto the processor 112 and/or various pieces of data may be loaded onto the processor 112. Examples of instructions and/or data that may be stored by the memory 122 may include time metric(s), network delay data, network delay profiler 114 instructions, processor operating factor(s), processor efficiency profile data, processing efficiency determiner 116 instructions, response requirement data, response requirement determiner 118 instructions, processor performance mode data, processing performance mode determiner 120 instructions, processing performance requirement data, processing performance requirement determiner 128 instructions, application type data, application(s) 130 instructions, usage metric(s) and/or user experience analyzer 132 instructions, etc.

The communication interface(s) 108 may enable the electronic device 102 to communicate with one or more other electronic devices. For example, the communication interface(s) 108 may provide one or more interfaces for wired and/or wireless communications. In some configurations, the communication interface(s) 108 may be coupled to one or more antennas 110 for transmitting and/or receiving radio frequency (RF) signals. Additionally or alternatively, the communication interface 108 may enable one or more kinds of wireline (e.g., Universal Serial Bus (USB), Ethernet, etc.) communication.

In some configurations, multiple communication interfaces 108 may be implemented and/or utilized. For example, one communication interface 108 may be a cellular (e.g., 3G, Long Term Evolution (LTE), CDMA, etc.) communication interface 108, another communication interface 108 may be an Ethernet interface, another communication interface 108 may be a universal serial bus (USB) interface, and yet another communication interface 108 may be a wireless local area network (WLAN) interface (e.g., Institute of Electrical and Electronics Engineers (IEEE) 802.11 interface). In some configurations, the communication interface 108 may send information to and/or receive information from one or more other devices (e.g., server(s), smartphone(s), camera(s), display(s), drone(s), vehicle(s), etc.). Examples of information that may be sent may include data requests (e.g., web page requests, file requests, text data requests, audio data requests, image data requests, video data requests, application data requests, etc.), remote commands (e.g., drone control commands, remote computing commands, etc.), upload data (e.g., audio data, video data, image data, text data, gaming data, etc.), etc. Examples of information that may be received may include web page data, file data, audio data, image data, text data, video data, gaming data, software object(s), application data, etc.

The input device(s) 104 may be one or more devices that provide input to the electronic device 102. One or more of the input device(s) 104 may be included in (e.g., integrated into) or coupled to the electronic device 102. Examples of input device(s) 104 may include touchscreens (e.g., touchscreen monitors), mice, keyboards, digital pens, touch pads, cameras (e.g., camera for detecting gestures, such as depth sensors, time-of-flight (TOF) cameras, visual spectrum cameras, etc.), presentation remotes, laser pointers, videogame controllers, microphones (e.g., audio microphones for voice commands, ultrasonic microphones for digital pens, etc.), infrared receivers, etc.

Some configurations of the electronic device 102 (e.g., input device(s) 104) may include one or more cameras (e.g., image sensor(s), optical system(s), lens(es), etc.). For example, the electronic device 102 may obtain one or more images (e.g., digital images, image frames, frames, video, etc.). For instance, the electronic device 102 may include image sensor(s) and optical system(s) (e.g., lenses) that focus images of scene(s) and/or object(s) that are located within the field of view of the optical system onto the image sensor. The optical system(s) may be coupled to and/or controlled by the processor 112 in some configurations. A camera (e.g., a visual spectrum camera or otherwise) may include at least one image sensor and at least one optical system. In some configurations, the image sensor(s) may capture the one or more images (e.g., image frames, video, still images, burst mode images, etc.).

The output device(s) 106 may be one or more devices that provide output from the electronic device 102. One or more of the output device(s) 106 may be included in (e.g., integrated into) or coupled to the electronic device 102. Examples of output device(s) 106 may include display(s) 124 (e.g., touchscreens, touchscreen monitors), speakers, printers, etc. It should be noted that an input device 104 and an output device 106 may be integrated in some configurations. For example, a touchscreen may be a display with an integrated touch sensor.

The display(s) 124 may be integrated into the electronic device 102 and/or may be coupled to the electronic device 102. Examples of the display(s) 124 include liquid crystal display (LCD) screens, light emitting display (LED) screens, organic light emitting display (OLED) screens, plasma screens, cathode ray tube (CRT) screens, etc. In some implementations, the electronic device 102 may be a smartphone with an integrated display. In another example, the electronic device 102 may be coupled to one or more remote displays 124 and/or to one or more remote devices that include one or more displays 124.

In some configurations, the electronic device 102 may present a user interface 126 on the display 124. For example, the user interface 126 may enable a user to interact with the electronic device 102. In some configurations, the user interface 126 may enable a user to establish operating setting(s) and/or to interact with one or more applications (e.g., application(s) 130, web browser(s), game(s), remote controller(s), etc.). For example, the electronic device 102 (e.g., user interface 126) may receive a touch, a mouse click, a keyboard input, a gesture and/or some other indication that indicates an input. In some configurations, the display 124 may be a touch display (e.g., a touchscreen display). For example, a touch display may detect the location of a touch input. The location of a touch input may indicate a particular action and/or manipulation of a user interface 126 control.

The processor 112 may include and/or implement a network delay profiler 114. The network delay profiler 114 may determine a network delay. For example, the network delay profiler 114 may obtain (e.g., receive and/or determine) one or more time metrics. A time metric may be data that may be utilized to determine a network delay (e.g., round-trip time (RTT)) for one or more interactions between the electronic device 102 and a network. Examples of time metrics may include request time, response time, ping send time, ping response time, packet time stamp, object response time, etc. For instance, a request time may be a time at which the electronic device 102 sends a request (e.g., a get operation, a post operation, etc.) and/or a response time may be a time when a response to the request is received (e.g., when the first bit of the response is received). In some configurations, determining the network delay may include measuring a time between the request time and the response time. Additionally or alternatively, determining the network delay may include measuring a time between the ping send time and the ping response time. In some approaches, the network delay profiler 114 may determine an average network delay, a worst-case network delay, etc. For example, the network delay profiler 114 may determine a plurality of network delays and may determine an average of the network delays or a worst-case (e.g., longest) of the network delays (as the network delay, for instance).

In some configurations, the electronic device 102 may send one or more requests and may receive one or more items (e.g., objects, images, videos, audio, packets, etc.). The network delay profiler 114 may determine a network delay for each of the items received. For example, the network delay profiler 114 may utilize one or more time stamps for one or more received packets (including data for one or more items, for instance) to determine one or more network delays. For instance, the network delay profiler 114 may determine a difference between a request send time and a time stamp for one or more received packets to determine one or more network delays. The network delay profiler 114 may determine an average or worst case network delay (of multiple network delays) in some approaches.

The processor 112 may include and/or implement a processing efficiency determiner 116. The processing efficiency determiner 116 may determine a processing efficiency profile (e.g., processing energy efficiency profile, processing power efficiency profile, etc.). In some configurations, the processing efficiency determiner 116 may determine the processing efficiency profile based on one or more factors (e.g., processor operating factors, inputs, etc.). For example, the processing efficiency determiner 116 may determine the processing efficiency profile based on operating frequency (e.g., operating clock frequency), operating voltage (e.g., operating voltage level), a number of active function blocks, types of active function blocks, silicon leakage per part and/or temperature readings (from embedded temperature sensor(s), for instance).

The processing efficiency determiner 116 may utilize one or more approaches to determine the processing efficiency profile (e.g., to get the input factor(s) and/or generate the processing energy efficiency). In one approach, the processing efficiency determiner 116 may determine the processing efficiency profile based on actual real-time measurement of instructions (e.g., Million Instructions Per Second (MIPS)) and power (e.g., milliwatts (mW)). In other approaches, the processing efficiency determiner 116 may determine the processing efficiency profile based on a processing efficiency model (e.g., predetermined processing efficiency model). For example, the processing efficiency determiner 116 may look up the processing efficiency profile from a predetermined look-up table having information for processing efficiency (e.g., energy efficiency levels) for one or more input factors. In another example, the processing efficiency determiner 116 may determine the processing efficiency profile based on a mathematical formulaic model calculating the processing efficiency (e.g., processing energy efficiency) from one or more input factors. In yet another approach, the processing efficiency determiner 116 may determine the processing efficiency profile based on received information for processing efficiency (e.g., processing energy efficiency) from a remote device (e.g., server) having the processing efficiency profile (e.g., energy efficiency model) using input factors sent from the electronic device 102 (e.g., local device).

Processing efficiency (e.g., processing energy efficiency) may indicate an amount of processing completed (e.g., Million Instructions Per Second (MIPS)) for an amount of power (e.g., milliwatts (mW)) expended. Some factors that may affect processing efficiency are operating frequency (e.g., operating clock frequency), operating voltage (e.g., operating voltage level), a number of active function blocks, types of active function blocks, silicon leakage per part and/or temperature readings.

In some configurations, the processing efficiency profile may include one or more (e.g., a set of) processing efficiencies (e.g., processing energy efficiencies) corresponding to one or more (e.g., a set of) processing performance modes. For example, the processing efficiency determiner 116 may determine one or more processing efficiencies (e.g., processing energy efficiencies) respectively corresponding to one or more processing performance modes. The processing efficiency profile may span an entire operating range (over frequency, for example) or a subset of an operating range (e.g., a subset of frequencies). For example, the processing efficiency determiner 116 may determine the processing efficiency profile (e.g., processing efficiencies) for all possible processing performance modes or for a subset of processing performance modes.

In some configurations, the processing efficiency determiner 116 may determine the processing efficiency profile based on a processing efficiency model (e.g., a simplified processor power model). The processing efficiency model may indicate processing efficiency for one or more processors 112 for one or more input factors (e.g., set(s) and/or range(s) of one or more factor(s)). For example, a processing efficiency model may indicate processing energy efficiency over a range of operating frequencies for one or more processor(s) 112. Additionally or alternatively, a processing efficiency model may indicate processing efficiency over a range of operating frequencies for a range of operating voltages, for a range of number of active blocks, for different types of active function blocks, for a range of silicon leakage and/or for a range of temperatures for one or more processor(s) 112. In some implementations, the processing efficiency model may be stored in memory 122. For example, the processing efficiency model may be implemented as a look up table in memory 122. In some implementations, the processing efficiency model may be a mathematical formulaic model for calculating the processing efficiency profile (e.g., processing efficiencies).

The processing efficiency model may be predetermined and/or determined dynamically (e.g., in real time). For example, the processing efficiency determiner 116 may observe processing efficiency data and store the processing efficiency data in memory 122 (e.g., in a look up table) as the processing efficiency model. In some approaches, the processing efficiency determiner 116 may observe (e.g., detect, record, etc.) processing efficiency data. For example, the processing efficiency determiner 116 may observe (e.g., measure, profile, etc.) an amount of processing completed (e.g., million instructions per second (MIPS)) for an amount of power (e.g., milliwatts (mW)) expended. For example, the processing efficiency determiner 116 may observe instruction execution (e.g., run a set of test instructions, observe instructions being executed, etc.) and an amount of power supplied to the processor(s) 112 for the instruction execution.

In some approaches, the processing efficiency determiner 116 may observe the amount of processing and power expenditure at different processor 112 operating frequencies. For example, the processing efficiency determiner 116 may observe the amount of processing and corresponding power expenditure over a set of processor 112 operating frequencies for a set of instructions (e.g., test instructions or routine instructions). In some configurations, the processing efficiency determiner 116 may store one or more kinds of processing efficiency data (e.g., amount(s) of processing, power expenditure(s), operating frequency(ies), temperature(s), silicon leakage per part, operating voltage(s), etc.). The processing efficiency data may be stored in the memory 122. For example, the processing efficiency data may be stored in a look up table in the memory 122 as the processing efficiency model.

Additionally or alternatively, the processing efficiency determiner 116 may determine the processing efficiency model from a formulaic model based on the processing efficiency data. For example, the processing efficiency determiner 116 may perform polynomial regression or curve fitting to determine a formulaic model that represents the processing efficiency data.

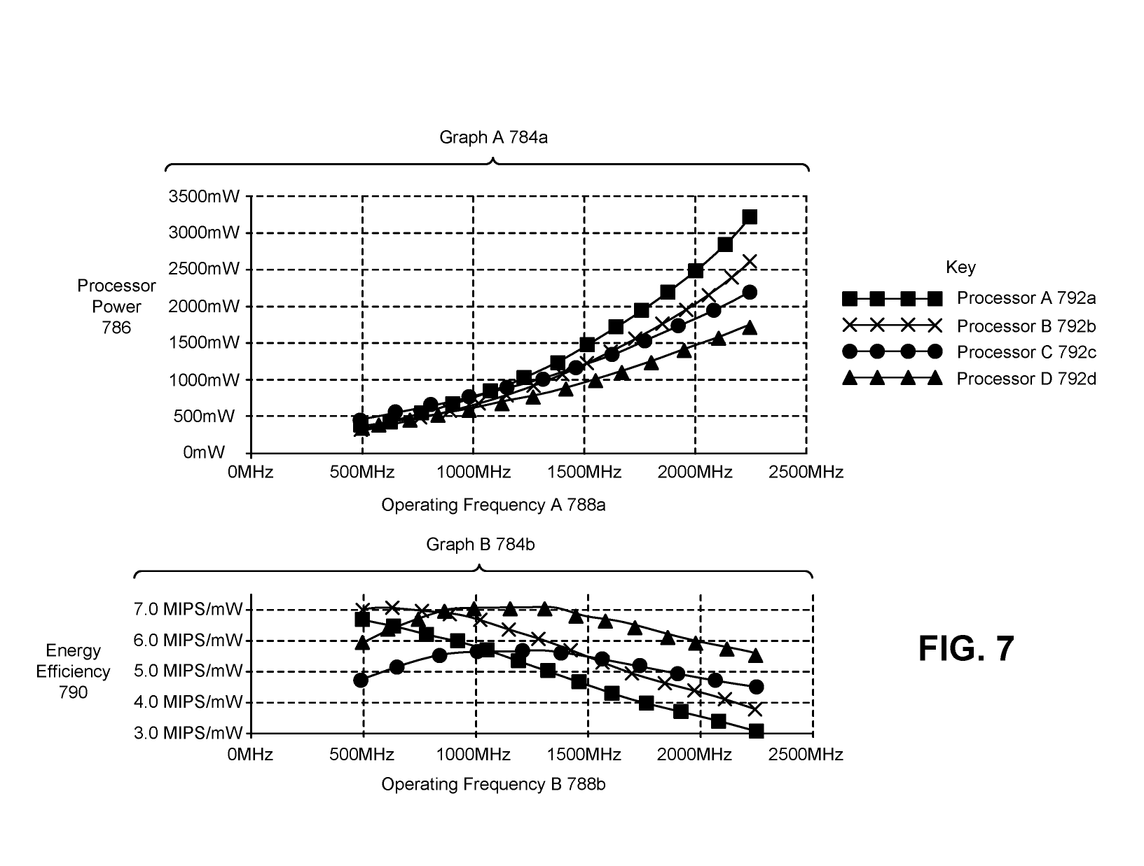

In some implementations, the processing efficiency model may be implemented on a remote device (e.g., on a remote server as a look up table or a mathematical formulaic model). For example, the electronic device 102 may send one or more input factors (e.g., operating frequency, temperature, active blocks, etc.) to a remote device via the communication interface(s) 108 and may receive the processing efficiency profile (e.g., processing efficiencies) based on the input factor(s). In some configurations, the processing efficiency determiner 116 may receive processing efficiency data and/or the processing efficiency profile from a remote device. For example, the processing efficiency determiner 116 may request and/or receive processing efficiency data and/or the processing efficiency profile from a remote device (e.g., remote server, remote electronic device, etc.) via the communication interface 108. For instance, a remote device may provide a general (e.g., default) processing efficiency model for the type of processor(s) 112 included in the electronic device 102. The processing efficiency model may be stored in the memory 122 (e.g., in a look up table). Examples of processing efficiency models are described in connection with FIG. 7.

The processing efficiency determiner 116 may determine the processing efficiency profile (e.g., processing energy efficiency profile) based on the processing efficiency model. For example, the processing efficiency determiner 116 may determine (e.g., look up, calculate, compute, etc.) a set of processing energy efficiencies (e.g., MIPS per mW) corresponding to a set of processing performance modes (e.g., operating frequencies). In some configurations, the processing efficiency determiner 116 may look up the set of energy efficiencies (e.g., predetermined estimated processing energy efficiencies) from a look up table as the processing efficiency profile. Additional or alternative processing efficiency data may be stored in the look up table (e.g., temperature, silicon leakage, operating voltage, operating frequency, etc.). Storing the energy efficiency model in a look up table may enable look up of one or more energy efficiencies based on one or more factors (e.g., operating frequency, temperature, etc.). Looking up the processing efficiency profile may be simpler and/or may not require real-time measurement of an amount of processing completed (e.g., million instructions per second (MIPS)) for an amount of power (e.g., milliwatts (mW)) expended.

Additionally or alternatively, the processing efficiency determiner 116 may determine the processing efficiency profile from a formulaic model based on the processing efficiency data. For example, the processing efficiency determiner 116 may calculate (e.g., compute) the processing efficiency profile from the formulaic model based on the input(s).

In some approaches, determining the processing efficiency profile may include determining a set of processing efficiencies (e.g., processing energy efficiencies) corresponding to a set of processing performance modes. For example, each processing performance mode may have one or more operating characteristics. For instance, each processing performance mode may indicate an operating frequency (e.g., operating clock frequency), an operating voltage (e.g., operating voltage level), a number of active function blocks and/or types of active function blocks. The processing efficiency determiner 116 may determine the processing efficiency profile by determining processing efficiencies based on the one or more operating characteristics (e.g., frequency, operating voltage, number and/or type of active function blocks, etc.) corresponding to each processing performance mode. For example, the processing efficiency determiner 116 may determine (e.g., look up, calculate, compute, request and/or receive) one or more processing efficiencies based on the operating frequencies of one or more corresponding processing performance modes. For instance, one or more processing efficiencies may be extracted from a look up table with the operating frequency(ies) as indices, may be determined from a processor power model with the operating frequency(ies) as input and/or may be calculated with a formulaic model with the operating frequency(ies) as input, etc. Additional or alternative factors may be utilized to determine the processing efficiencies. The processing efficiency profile may include, may indicate and/or may be the one or more processing efficiencies (e.g., a set of processing efficiencies) corresponding to the one or more processing performance modes. In some implementations, other factors (e.g., silicon leakage per part, temperature readings and/or temperature estimates, etc.) may be utilized in determining the processing efficiency profile.

The processor 112 may include and/or implement a response requirement determiner 118. The response requirement determiner 118 may determine (e.g., compute and/or receive) a response requirement. A response requirement may be an amount of time within which the electronic device 102 (e.g., application 130) is required to respond to an input. For example, the response requirement may reflect a desired responsiveness for an application 130. For instance, web browser responsiveness may be acceptable (or good) when responding to an input within the response requirement, whereas web browser responsiveness may be poor (or unacceptable) when responding to an input outside of the response requirement. A response may occur at a time when an output (e.g., image data is displayed, a sound is output, tactile feedback is provided, etc.) is provided in response to the input. For example, the response may be an actual output of an operation. For instance, a response may not include a mere indication of an operation in process (e.g., progress bars, spinning wheel icons, turning hourglass icons, etc.). In a configuration where the operation is a request for web content, for example, a response may occur when at least one element of the requested web content is presented (e.g., displayed). In some approaches, a response may be considered to occur when at least one element is displayed. In other approaches, a response may be considered to occur when all of the requested elements are displayed.

In some configurations, the response requirement determiner 118 may determine the response requirement based on an application type. For example, different application types (e.g., web browsing, network gaming, remote control, remote computing, etc.) may have different associated response requirements. For instance, the electronic device 102 may store response requirements (in the memory 122 and/or in a look up table, for example) for each application type. The response requirement determiner 118 may determine the response requirement by accessing (e.g., looking up) the response requirement for a particular application type (when the application is in use, for example). In some approaches, different applications 130 within an application type may have different response requirements (e.g., Chrome may have a different response requirement than Safari or Internet Explorer).

In some configurations, the response requirement determiner 118 may determine the response requirement additionally or alternatively based on a data type. For example, different data types (e.g., text, images (e.g., Joint Photographic Experts Group (JPG), Tagged Image File Format (TIFF), Portable Network Graphic (PNG), bitmap (BMP), Graphics Exchange Format (GIF), etc.), videos (e.g., Moving Picture Experts Group (MPEG), QuickTime, Windows Media Video (WMV), 3GP, etc.), Extensible Markup Language (XML), HyperText Markup Language (HTML), object types, etc.) may have different associated response requirements. For instance, the electronic device 102 may store response requirements (in the memory 122 and/or in a look up table, for example) for each data type. The response requirement determiner 118 may determine the response requirement by accessing (e.g., looking up) the response requirement for a particular data type.

In some approaches, one or more of the response requirements may be predetermined. For example, a response requirement (for a particular application type and/or data type, for instance) may have a predetermined and/or a default value. One or more of the response requirements may be static or variable. In some configurations, a variable response requirement may be varied based on detected user behavior and/or settings. For example, the electronic device 102 may receive an input (e.g., user preference setting) that indicates a response time for a particular application type (e.g., web browsing, network gaming, remote control, remote computing, etc.).

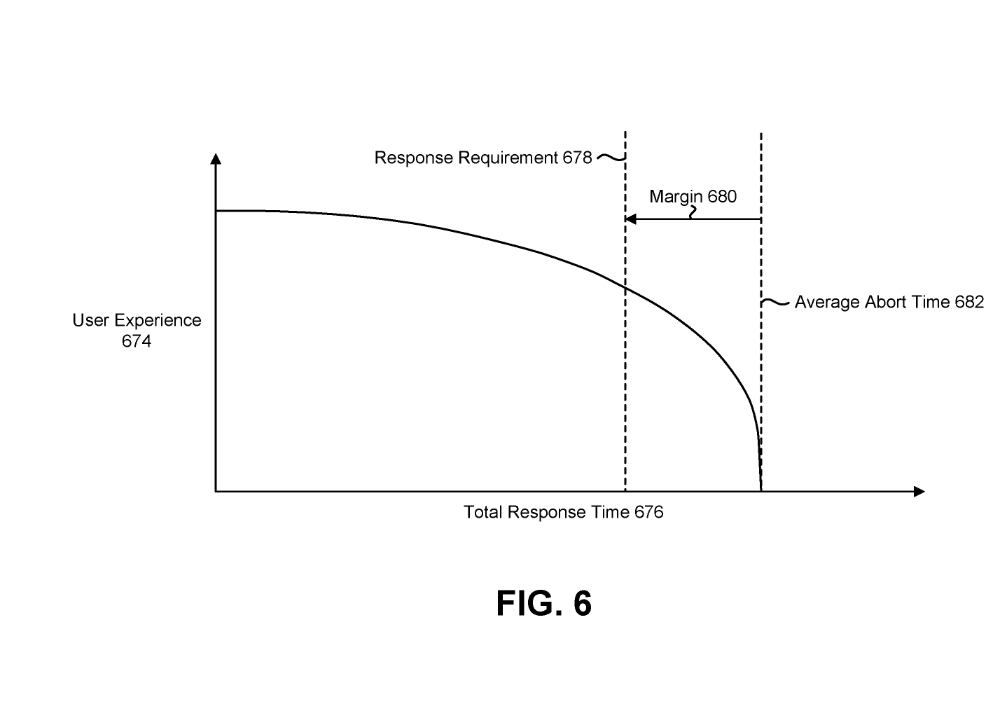

Additionally or alternatively, the response requirement determiner 118 may detect user behavior (e.g., wait time before aborting a web page request or accessing a different page) and may establish or adjust the response requirement based on the detected behavior. For example, the response requirement determiner 118 may optionally include a user experience analyzer 132. In some configurations, the user experience analyzer 132 may analyze one or more usage metrics (e.g., received input, detected user behavior, etc.) to determine the response requirement. For instance, the user experience analyzer 132 may determine an amount of time (e.g., abort time, average abort time, etc.) for which a user waits for a response before aborting an operation (e.g., before receiving an input attempting another operation, stopping the operation and/or shutting down the application). In one example, the user experience analyzer 132 may detect one or more times (e.g., an average time) where a web page is attempting to be accessed but where browsing is aborted or a different page is requested before the web page is loaded. The response time for that application (and/or application type) may be adjusted in accordance with the abort time(s). For instance, the response requirement may be determined as the average abort time minus a margin (e.g., a predetermined margin). One example of determining the response requirement is given in connection with FIG. 6.

The processor 112 may include and/or implement a processing performance mode determiner 120. The processing performance mode determiner 120 may include a processing performance requirement determiner 128. The processing performance requirement determiner 128 may determine a processing performance requirement based on a time difference between the response requirement and the network delay. The processing performance requirement may be an amount of time within which the processor 112 may produce a response (e.g., render an item on a webpage, in order to meet the response requirement.

In some configurations, the processing performance requirement determiner 128 may determine the processing performance requirement as the difference between the response requirement and the network delay. For instance, the processing performance requirement determiner 128 may subtract the network delay from the response requirement to yield the processing performance requirement.

The processing performance mode determiner 120 may determine (e.g., select) a processing performance mode. The processing performance mode may be a mode of operation for the processor(s) 112. For example, the processing performance mode may include and/or indicate a processor operating frequency (e.g., cycle frequency, clock frequency, etc.). Additionally or alternatively, the processing performance mode may include and/or indicate an operating policy (e.g., DCVS setting, big.LITTLE processor scheduler setting, etc.). The processing performance mode may indicate and/or control how quickly the processor(s) 112 operate (e.g., process data, execute instructions, etc.). The processing performance mode may also impact the processing efficiency (e.g., processing energy efficiency). In some cases, for example, operating a processor 112 at a higher frequency may complete operations more quickly, but at a cost of lower efficiency. Processing efficiency may impact energy consumption, which may impact battery life for some platforms.

The processing performance mode determiner 120 may determine the processing performance mode based on the processing performance requirement and the processing efficiency profile (e.g., processing energy efficiency profile). For example, a processing performance mode may satisfy the processing performance requirement if the processor(s) 112, when operating in the processing performance mode (to process a workload, for example), may produce a response within the processing performance requirement (upon receiving data from the network, for example) and/or may produce a response within the response requirement when taking the network delay into account.

In some configurations, the processing performance mode determiner 120 may determine whether one or more processing performance modes (e.g., operating frequencies) may produce a response within the processing performance requirement based on a workload. The workload may be a number of instructions for execution and/or an amount of data to be processed. The workload may be estimated ahead of and/or during (e.g., in the middle of) processing. In some approaches, the processor 112 (e.g., processing performance mode determiner 120) may measure the workload for one round of response and may assume that the next round of processing for the next response will have a similar (e.g., the same) workload. For example, the electronic device 102 (e.g., processor 112, processing performance mode determiner 120, etc.) may measure the number of instructions executed (in MIPS/second, for instance) and/or the number of data accesses to memory (in megabytes per second (Mbytes/sec), for instance) by reading performance counter registers in hardware. By reading these counter registers periodically for predetermined time periods, the electronic device 102 (e.g., processor 112, processing performance mode determiner 120, etc.) may calculate MIPS/sec and Mbytes/sec. In some approaches, electronic device 102 (e.g., processor 112, processing performance mode determiner 120, etc.) may estimate the total execution workload based on an amount of input data to be processed (e.g., objects such as text, video, image, sound, etc.). For example, encoding a larger resolution video frame in video conferencing may be estimated to require a larger processing workload than encoding a smaller resolution video frame. In some approaches, electronic device 102 (e.g., processor 112, processing performance mode determiner 120, etc.) may estimate the remaining execution workload based on a ratio of remaining input data to processing performance measured so far. This may be accomplished in accordance with Equation (1) in some configurations.

$$\frac{( Total\_Original \_Input \_Data - Processed\_Input \_Data )}{Processing\_Performance} \qquad ( 1 )$$

In some configurations, the processing performance mode determiner 120 may determine the most efficient processing performance mode that satisfies the processing performance requirement. For example, the processing performance mode determiner 120 may determine the processing efficiencies (e.g., processing energy efficiencies) for each of the processing performance modes that satisfy the processing performance requirement. For instance, the processing performance mode determiner 120 may obtain the processing efficiency profile (e.g., processing energy efficiencies) for the processing performance modes that satisfy the processing performance requirement. In some configurations, the processing performance mode determiner 120 may request and/or receive the processing efficiency profile from the response requirement determiner 118. The processing performance mode determiner 120 may determine (e.g., select) the most efficient processing performance mode from the processing performance modes that satisfy the processing performance requirement. For example, the processing performance mode determiner 120 may select, from one or more processing performance modes, a processing performance mode corresponding to a highest associated processing efficiency (e.g., highest processing energy efficiency, etc.) indicated by the processing efficiency profile. The highest associated processing efficiency may be the highest associated processing efficiency of processing efficiencies corresponding to the one or more processing performance modes that satisfy the processing performance requirement (which may or may not be the highest possible efficiency of all of the efficiencies corresponding to all of the possible performance modes). In some configurations, the processing performance mode determiner 120 may determine a range of processing performance modes (e.g., operating frequencies) that would satisfy the processing performance requirement.

It should be noted that the processing performance mode may be determined (e.g., selected) from a range and/or set of processing performance modes in some configurations. For example, the processor(s) 112 may be set (e.g., adjusted) to operate in accordance with any of a range and/or set of processing performance modes. For instance, the processor(s) 112 may be operable over a range of and/or in a set of different operating frequencies.

The electronic device 102 (e.g., processing performance mode determiner 120) may operate the processor(s) 112 based on the processing performance mode (e.g., the determined processing performance mode). For example, the electronic device 102 (e.g., processing performance mode determiner 120) may set the processor(s) 112 to operate at an operating frequency of the determined processing performance mode. Additionally or alternatively, the electronic device 102 (e.g., processing performance mode determiner 120) may set the processor(s) 112 to operate in accordance with an operating policy (e.g., DCVS setting, big.LITTLE processor scheduler, etc.).

It should be noted that one or more of the elements or components of the electronic device 102 may be combined and/or divided. For example, the network delay profiler 114, the processing efficiency determiner 116, the response requirement determiner 118 and/or the processing performance mode determiner 120 may be combined. Additionally or alternatively, one or more of the network delay profiler 114, the processing efficiency determiner 116, the response requirement determiner 118 and/or the processing performance mode determiner 120 may be divided into elements or components that perform a subset of the operations thereof.

The systems and methods disclosed herein may provide one or more benefits. For example, the systems and methods disclosed herein may provide an improved user experience, where client processing performance (e.g., operating policy) may be dynamically adjusted based on network communication latency situations. Additionally or alternatively, the systems and methods disclosed herein may provide for longer battery life, with client processing performance configured for higher energy efficiency depending on per-part silicon characteristics and/or real-time temperature, within the performance range that meets the response requirement (e.g., user experience threshold).

It should be noted that the systems and methods disclosed herein may be implemented in many different contexts. For example, the systems and methods disclosed herein may be implemented for web browsing, network gaming (e.g., for local processing delay for gaming+network communication delay), real-time remote control (e.g., for local video/sensor processing delay+wireless/wired communication delay for drones, cars, robots, remote surgery, etc.), video telephone or video conferencing (e.g., for local video encoding and decoding+streaming in network), remote virtual reality (e.g., for local video/sensor processing delay+local video encoding and decoding+streaming in network+wireless/wired communication delay), etc.

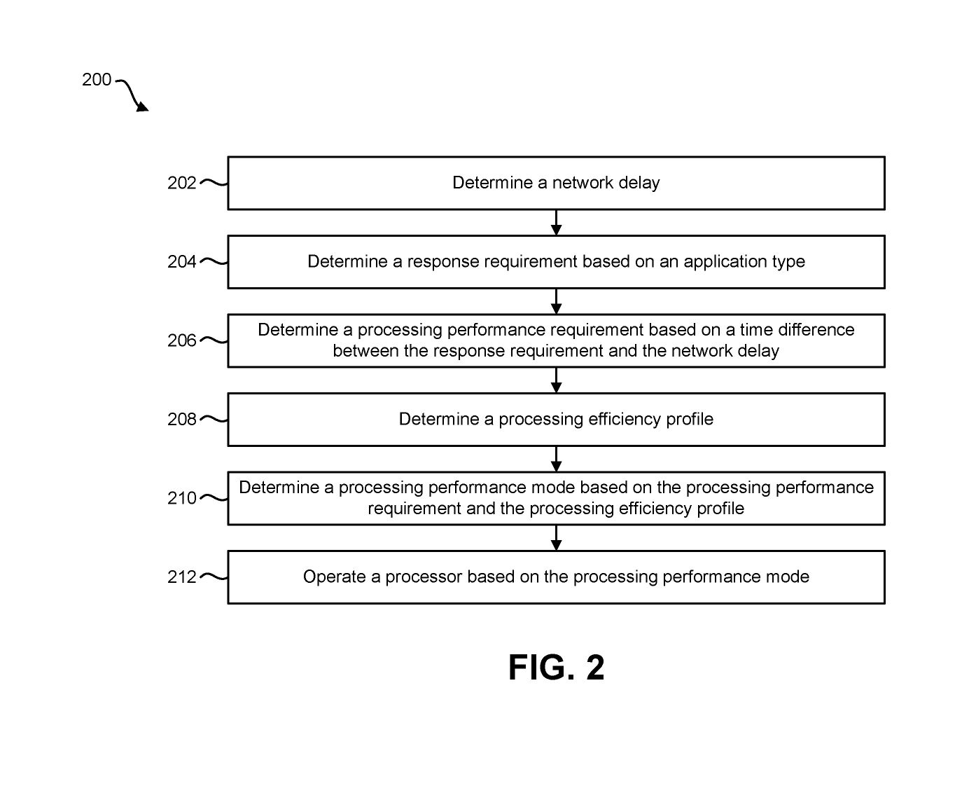

FIG. 2 is a flow diagram illustrating one configuration of a method 200 for controlling processor performance. The method 200 may be performed by an electronic device (e.g., the electronic device 102 described in connection with FIG. 1).

The electronic device 102 may determine 202 a network delay. This may be accomplished as described in connection with FIG. 1. For example, the electronic device 102 may utilize one or more time metrics (e.g., send time(s), response time(s) and/or time stamp(s), etc.) to determine the network delay.

The electronic device 102 may determine 204 a response requirement based on an application type. This may be accomplished as described in connection with FIG. 1. For example, the electronic device 102 may access (e.g., look up) and/or compute (e.g., analyze user behavior to determine) the response requirement corresponding to an application type (that is running, in use, for instance), specific application and/or data type.

The electronic device 102 may determine 206 a processing performance requirement based on a time difference between the response requirement and the network delay. This may be accomplished as described in connection with FIG. 1. For example, the electronic device 102 may subtract the network delay from the response requirement to determine the processing performance requirement.

The electronic device 102 may determine 208 a processing efficiency profile. This may be accomplished as described in connection with FIG. 1. For example, the electronic device 102 may determine and/or receive a processing efficiency profile (corresponding to one or more processor(s) 112, for instance). In some approaches, the processing efficiency profile may be based on a processing efficiency model. In some configurations, the processing efficiency profile may include one or more (e.g., a set of) processing efficiencies corresponding to one or more (e.g., a set of) processing performance modes.

The electronic device 102 may determine 210 a processing performance mode based on the processing performance requirement and the processing efficiency profile. This may be accomplished as described in connection with FIG. 1. For example, the electronic device 102 may determine a most efficient processing performance mode that satisfies the processing performance requirement.

The electronic device 102 may operate 212 a processor based on the processing performance mode. This may be accomplished as described in connection with FIG. 1. For example, the electronic device 102 may set (e.g., adjust) one or more processors 112 to operate in accordance with the processing performance mode (e.g., operating frequency, DCVS, big.LITTLE processor scheduler, etc.).

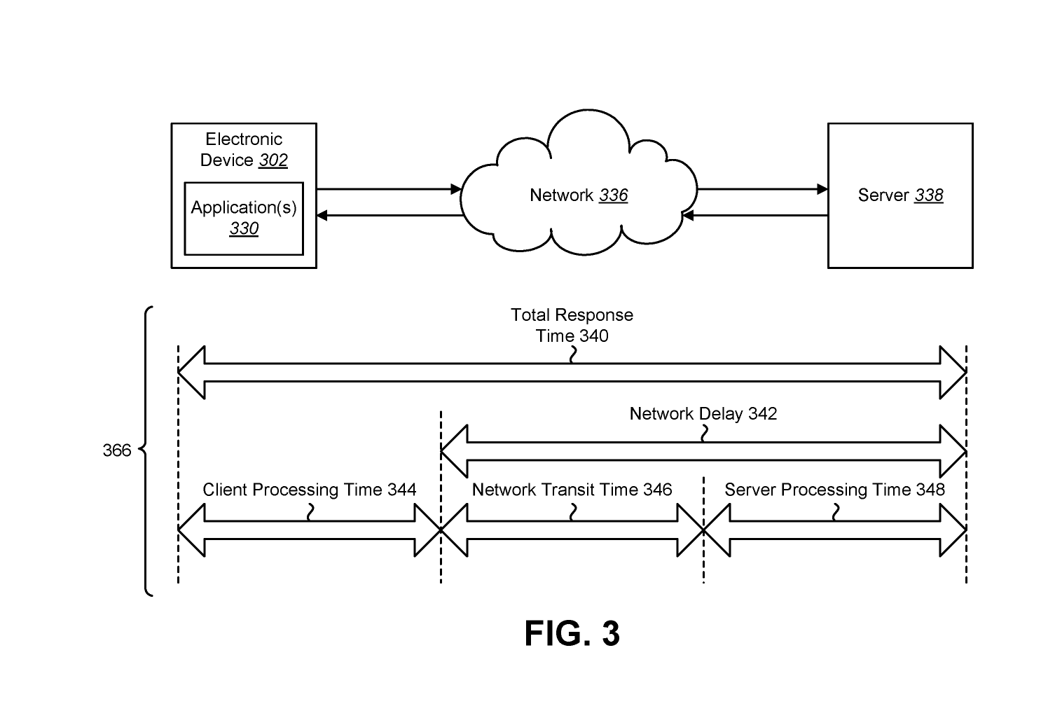

FIG. 3 includes a block diagram illustrating an example of network communication. Specifically, FIG. 3 illustrates an electronic device 302, a network 336 and a server 338. The electronic device 302 described in connection with FIG. 3 may be an example of the electronic device 102 described in connection with one or more of FIGS. 1-2. As illustrated in FIG. 3, the electronic device 302 may include one or more applications 330. The application(s) 330 may be an example of the application(s) 130 described in connection with FIG. 1.

The electronic device 302 (e.g., application(s) 330) may interact with a network 336. For example, the electronic device 302 may communicate with one or more servers 338 (and/or one or more other electronic devices) via a network 336. Examples of networks 336 include wireless networks (e.g., wireless local area networks (WLANs) (e.g., Institute of Electrical and Electronics Engineers (IEEE) 802.11 or “Wi-Fi” networks), wireless personal area networks (WPANs), wireless mesh networks, wireless metropolitan area networks (WMANs) (e.g., IEEE 802.16 or Worldwide Interoperability for Microwave Access (WiMAX)), wireless wide area networks, global area networks (GANs), etc.), cellular networks (e.g., 3G, LTE, CDMA, Global System for Mobile Communications (GSM), Universal Mobile Telecommunications System (UMTS), High-Speed Downlink Packet Access (HSDPA), etc.), wired networks, the Internet, home networks, local area networks (LANs), Ethernet networks, fiber networks, cable networks, etc., and combinations thereof. A network 336 may include one or more devices for enabling communication between the electronic device 302 and the server 338. For example, the network 336 may include one or more access points, modems, routers, switches, base stations (e.g., NodeBs, eNodeBs, etc.), servers, etc.

When the electronic device 302 performs operations that involve network 336 communication, certain delays may occur in producing a response. FIG. 3 includes a diagram 366 illustrating a simplified example of the delays that may occur (e.g., response time breakdown). For example, a total response time 340 may be the amount of time utilized to produce a response for an operation. As illustrated in FIG. 3, the total response time 340 may include client processing time 344 and network delay 342 (e.g., round-trip time (RTT)). Client processing time 344 may be the amount of time utilized by the electronic device 302 to perform local processing related to an operation. Network delay 342 may be the amount of time utilized for network 336 transit and server 338 processing related to the operation. As illustrated in FIG. 3, network delay 342 may include network transit time 346 and server processing time 348.

In one example, a web browser application 330 on the electronic device 302 may operate to obtain web content. For instance, the web browser application 330 may send a request for web content to the server 338 via the network 336. The request may take time to transit the network 336 and to be processed by the server 338. The server 338 may send the web content back to the electronic device 302 via the network 336, which may also require some time to transit the network 336. The electronic device 302 may receive the web content, unpack the web content, decode the web content and/or render the web content to produce the response.

As described above, some problems may affect user experience in this context. For example, one problem with some approaches may be that a static processing performance policy (e.g., DCVS or big.LITTLE CPU scheduler, etc.) may only be tuned and/or optimized for a few lab test cases regardless of real-world variation in network transit time 346 (e.g., network overhead time) and/or regardless of each user's different preference on battery life or total response time. For instance, some approaches utilize a static policy without dynamic adjustment for client processing time. Additionally or alternatively, network transit time 346 (e.g., network overhead time) may be dynamic, uncontrollable and/or unpredictable. Additionally or alternatively, server processing time 348 may be dynamic, uncontrollable and/or unpredictable. Accordingly, some approaches may not provide dynamic adjustment of device performance for improved total response time and/or energy consumption (e.g., battery life) achievable depending on dynamically changing network conditions.

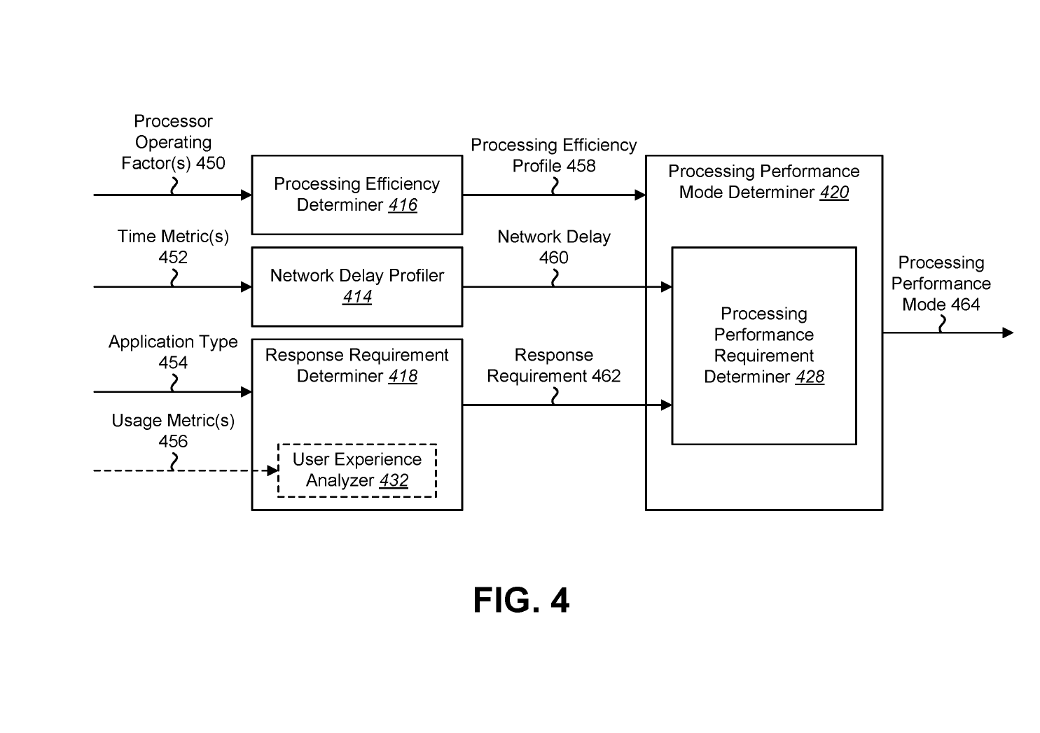

FIG. 4 is a block diagram illustrating examples of components or elements that may be implemented in an electronic device for controlling processing performance. Specifically, FIG. 4 illustrates a processing efficiency determiner 416, a network delay profiler 414, a response requirement determiner 418 (with an optional user experience analyzer 432) and a processing performance mode determiner 420 (including a processing performance requirement determiner 428). In some configurations, one or more of the components or elements described in connection with FIG. 4 may be examples of corresponding components or elements described in connection with FIG. 1. Additionally or alternatively, one or more of the components or elements described in connection with FIG. 4 may be implemented in the electronic device 102 described in connection with FIG. 1.

The systems and methods disclosed herein may be implemented for applications (e.g., client applications) that utilize both network communication and local processing (e.g., client processing). Examples of applications may include web browsing, messaging, SNS, network gaming, etc.

The network delay profiler 414 (e.g., RTT profiler) may determine a network delay 460. For example, the network delay profiler 414 may determine the network delay 460 based on one or more time metrics 452 (e.g., RTT measurement per object, per packet, etc.). This may be accomplished as described above in connection with FIG. 1. For instance, the network delay profiler 414 may monitor overall network delay 460, which may include network transit time and server processing time (e.g., RTT, including network latencies and server response time). In some implementations, the electronic device 102 (e.g., network delay profiler 414) may determine the network delay 460 based on one or more received data packets (e.g., received data packets from the network that may include time stamp information). Additionally or alternatively, the electronic device 102 (e.g., network delay profiler 414) may measure the time delay from the request time to arrival time. In some configurations, the network delay profiler 414 may determine the network delay 460 as an average RTT.

It should be noted that the electronic device 102 (e.g., network delay profiler 414) may not have control over network transit time and/or server processing time. For example, the electronic device 102 may not control server processing speed and/or may not control network traffic management, etc. For instance, the RTT portion may be uncontrollable and unpredictable from the electronic device 102 (e.g., client device). Accordingly, the electronic device 102 may adjust the processing performance based on the remaining time budget. The electronic device 102 (e.g., network delay profiler 414) may observe network delay 460 based on one or more time metrics 452 as described in connection with FIG. 1. The network delay 460 may be provided to the processing performance mode determiner 420.

The processing efficiency determiner 416 may determine a processing efficiency profile 458 (e.g., processing energy efficiency profile, processor energy efficiency, etc.). For example, the processing efficiency determiner 416 may determine a processing efficiency profile 458 based on one or more processor operating factors 450 (e.g., operating frequency, operating voltage, number of active function blocks, types of active function blocks, silicon leakage, silicon temperature readings, etc.). This may be accomplished as described above in connection with FIG. 1. For instance, the processing efficiency determiner 416 may determine (e.g., look up, calculate, request, receive, etc.) the energy efficiency of the electronic device 102 (e.g., client device, processor 112, etc.) for several processing performance modes (e.g., operating performance levels, operating frequencies, etc.). In some configurations, the processing efficiency profile 458 may be determined based on a processing efficiency model (e.g., simplified processor power model). The processing efficiency profile 458 may be provided to the processing performance mode determiner 420.

The response requirement determiner 418 may determine a response requirement 462 (e.g., response time threshold). For example, the response requirement determiner 418 may determine a response requirement 462 based on an application type 454. This may be accomplished as described in connection with FIG. 1. For instance, the response requirement 462 may indicate an amount of time within which the electronic device 102 (e.g., processor 112) is required to provide a response for a particular application (e.g., for an application that is in use). For example, meeting the response requirement 462 may help ensure a level of user experience (e.g., satisfactory user experience, good user experience, etc.). The response requirement 462 may be provided to the processing performance mode determiner 420.

In some configurations, the response requirement determiner 418 may include a user experience analyzer 432. The user experience analyzer 432 may analyze one or more usage metrics 456 (e.g., abort times, times before switching operations, times before shutting down an application, input(s) received indicating user behavior, etc.). The response requirement determiner 418 may determine and/or adjust the response requirement 462 based on the analysis performed by the user experience analyzer 432. For example, the response requirement determiner 418 may determine the response requirement 462 as an average abort time of downloading content minus a predetermined margin for a particular application type 454 (or specific application). Accordingly, the response requirement 462 of the client application may be a function of user experience in some configurations.

The processing performance mode determiner 420 may include a processing performance requirement determiner 428 (e.g., processor performance mode operating frequency level, etc.). The processing performance requirement determiner 428 may determine a processing performance requirement based on a time difference between the response requirement 462 and the network delay 460. This may be accomplished as described in connection with FIG. 1. For example, the processing performance requirement determiner 428 may calculate a remaining time budget to meet the response requirement 462 (e.g., user experience threshold).

The processing performance mode determiner 420 may determine (e.g., select) a processing performance mode 464. The processing performance mode determiner 420 may implement an algorithm to determine the processing performance mode 464 (e.g., electronic device 102 and/or processor(s) 112 performance mode). For example, the processing performance mode determiner 420 may determine the processing performance mode 464 based on the processing performance requirement and the processing efficiency profile 458. This may be accomplished as described in connection with FIG. 1. For example, the processing performance mode determiner 420 may determine a processing performance mode 464 based on the processor 112 performance (e.g., client device performance, operating frequency in megahertz (MHz)) needed to meet the processing performance requirement. For instance, the processing performance mode determiner 420 may determine a processing performance mode 464 that may process the operation (e.g., task) at a performance level with the best energy efficiency based on the processing efficiency profile 458 (e.g., estimated processing efficiency profile 458) within the performance range meeting the response requirement 462. The electronic device 102 (e.g., client device, processing performance mode determiner 420, etc.) may operate in accordance with the processing performance mode 464.

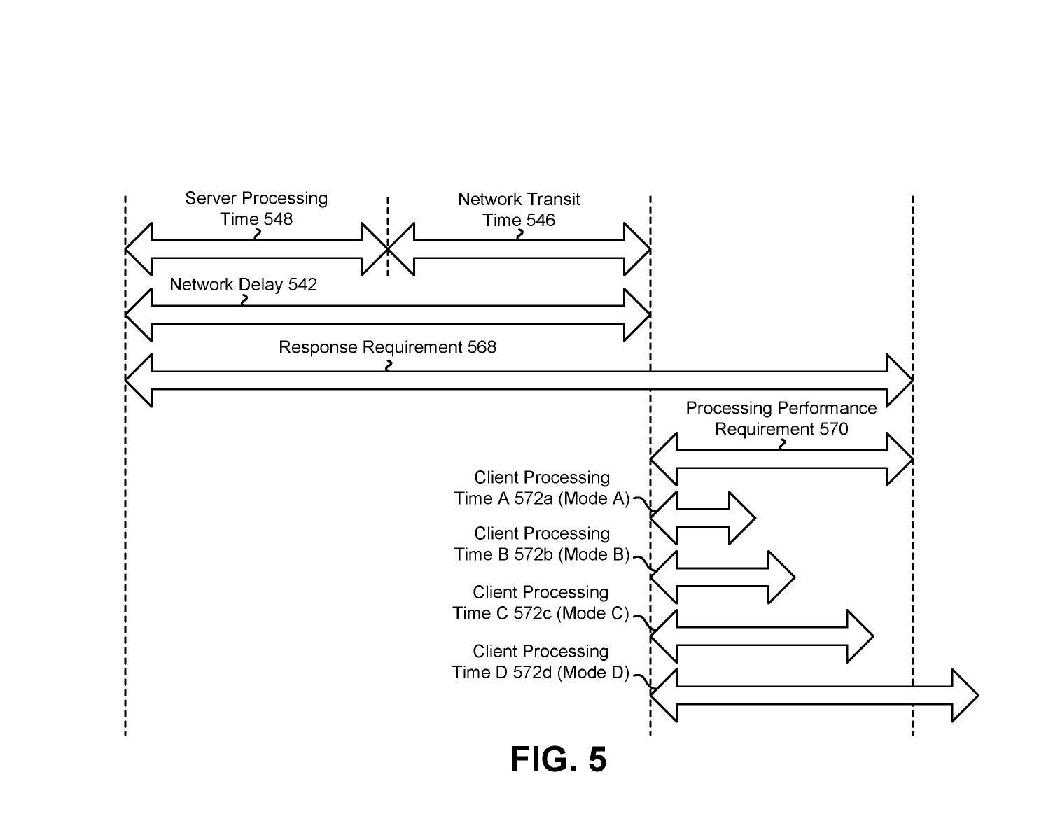

FIG. 5 is a diagram illustrating an example of determining a processing performance mode in accordance with the systems and methods disclosed herein. As described herein, a network delay 542 may include a server processing time 548 and a network transit time 546. In some configurations, the server processing time 548 may be dynamic, uncontrollable and/or unpredictable. For example, server processing time 548 may vary and the electronic device 102 may not control server processing. Additionally or alternatively, the network transit time 546 (e.g., network overhead time) may be dynamic, uncontrollable and/or unpredictable. For example, network transit time 546 may vary and the electronic device 102 may not control network transit time 546.

As described herein, the electronic device 102 may determine the network delay 542. For example, the electronic device 102 may monitor the network round-trip time (RTT).

The electronic device 102 may determine a response requirement 568 as described herein. The response requirement 568 may be based on an application type and/or based on usage metrics. For example, the response requirement 568 may be viewed as a response time threshold and/or a limit based on target user experience. For instance, the user experience may be a function of total response time. Accordingly, the response requirement 568 may establish a target user experience.

The electronic device 102 may determine a processing performance requirement 570 as described herein. For example, the processing performance requirement 570 may be a time difference between the response requirement 568 and the network delay 542 as illustrated in FIG. 5.

As described herein, one or more processors 112 may operate in accordance with a number of processing performance modes (e.g., operating frequencies). FIG. 5 illustrates client processing times 572a-d corresponding to a number of different possible processing performance modes. As illustrated in FIG. 5, the processing performance modes may offer different client processing times 572a-d. For example, different operating frequencies may utilize different client processing times 572a-d to complete an operation.

The electronic device 102 (e.g., processing performance mode determiner 120, 420) may determine a set of processing performance modes (e.g., processing performance times) that would satisfy the processing performance requirement 570. As illustrated in FIG. 5, client processing times A-C 572a-c correspond to performance modes that may meet the processing performance requirement 570 and/or the response requirement 568 (e.g., time threshold). More specifically, any of client processing times A-C 572a-c (e.g., processing performance modes A-C) would satisfy the processing performance requirement 570, since they are less than or equal to the processing performance requirement 570. However, client processing time D 572d (e.g., processing performance mode D) would not meet the processing performance requirement 570 because it is greater than the processing performance requirement 570.

As described herein, the electronic device 102 may determine a processing efficiency profile. The processing efficiency profile may indicate the processing efficiencies for one or more processing performance modes (e.g., operating frequencies). For example, the processing efficiency profile may indicate the processing efficiencies of the processing performance modes A-C (and optionally processing performance mode D).

The electronic device 102 (e.g., processing performance mode determiner 120, 420) may determine a processing performance mode based on the processing performance requirement 570 and the processing efficiency profile. For example, the electronic device 102 (e.g., processing performance mode determiner 120, 420) may determine the processing performance mode that has the best energy efficiency with a corresponding client processing time 572 within the processing performance requirement 570 (e.g., range) that meets the response requirement 568. For instance, the processing performance mode determiner 120, 420 may select the processing performance mode from processing performance modes A-C that offers the best energy efficiency. The energy consumption (e.g., battery life) may be a function of the processing performance mode (e.g., client performance policy).

FIG. 6 is a graph illustrating an example of user experience 674 over total response time 676. The user experience 674 (e.g., user experience indicator) may be modeled with a simplified curve to represent the response requirement 678 (e.g., response time threshold for a target processing time, overall response time, etc.). As can be observed in FIG. 6, user experience 674 may decline as the total response time 676 increases. For example, a user may want and/or expect an application to respond within an amount of time to provide a satisfactory experience. However, if total response time 676 gets too large, the operation may eventually be aborted (e.g., the electronic device 102 may receive an input indicating ending the current operation and/or switching to a different operation).

As illustrated in FIG. 6, a user experience analyzer 132, 432 may determine an average abort time 682. For example, the user experience analyzer 432 may observe (e.g., detect, store, etc.) a number of abort times as usage metrics 456 and may average the abort times to determine the average abort time 682. For example, the average abort time 682 may be an average time for when the user aborted downloading web content (e.g., aborting a web page download and re-trying the same or a different web page download). Accordingly, the user experience analyzer 432 may adjust the timeline based on actual user behavior.

The electronic device 102 (e.g., response requirement determiner 118, 418) may determine a response requirement 678 based on the average abort time 682 and a margin 680 (e.g., a predetermined margin). For example, the response requirement 678 may be view as a total response time threshold, which may be equal to a processing performance requirement plus the network delay (e.g., processing time target plus RTT).

FIG. 7 includes graphs 784a-b that illustrate examples of processor power consumption and energy efficiency. More specifically, graph A 784a illustrates processor (e.g., CPU) power consumption 786 over operating frequency A 788a for processors A-D 792a-d. Graph B 784b illustrates processor energy efficiency 790 (e.g., an example of one or more processing energy efficiency models) over operating frequency B 788b for processors A-D 792a-d.

As illustrated by graphs A-B 784a-b, processor power consumption and energy efficiency may be modeled as described herein. For example, the electronic device 102 (e.g., processing efficiency determiner 116, 416) may utilize input information (e.g., silicon leakage per part (e.g., eFuse in silicon), operating voltage (e.g., eFuse in silicon), silicon temperature readings (from embedded temperature sensors), etc.) to determine processor power consumption 786 and/or energy efficiency 790. It should be noted that in some configurations, eFuse may be a register (e.g., electrically erasable programmable read-only memory (EEPROM)) with values programmed during manufacturing and testing of the electronic device 102. For example, eFuse may have fixed preprogrammed values indicating characteristics or key permanent settings of the electronic device 102. It should be noted that silicon integrated circuit (IC) processor power consumption 786 may vary depending on one or more conditions (e.g., part-to-part variation, changes according to silicon temperature, etc.).

Graph A 784a illustrates different power characteristics in cases of four different processors 792a-d. Of processors A-D 792a-d, for example, processor A 792a is the slowest silicon with low leakage; processor B 792b is slow silicon with low leakage; processor C 792c is fast silicon with high leakage (at high temperature); and processor D 792d is the fastest silicon with low leakage.

Graph B 784b illustrates different energy efficiency characteristics (e.g., processing efficiency model(s)) in cases of four different processors 792a-d. As illustrated in graph B 784a, processors A-D 792a-d may operate at higher energy efficiencies at some operating frequencies and at lower energy efficiencies at other operating frequencies. One or more of the plots illustrated in graph B 784b may represent a processing efficiency model (of processing energy efficiency 790 versus operating frequency B 788b). In some configurations, processor power consumption 786 may also be included in a processing efficiency model. Additional or alternative factors may be included in a processing efficiency model (e.g., operating voltage, number of active block(s), type(s) of active block(s), leakage, temperature, etc.).

In accordance with the systems and methods disclosed herein, the electronic device 102 (e.g., processing performance mode determiner 120, 420) may determine a processing performance mode (e.g., the most efficient processing performance mode from a set of processing performance modes). For example, once the processing performance requirement (e.g., time budget for the client processing portion) is calculated, the minimum processor operating frequency (e.g., performance level) may be calculated by the electronic device 102 (e.g., processing performance mode determiner 120). In some configurations, a minimum processor operating frequency (that may satisfy the processing performance requirement) may be determined in accordance with Equation (2).

$$Operating\_Frequency \geq ( \frac{Workload}{Processing\_Performance} ) \qquad ( 2 )$$

In Equation (2), Operating_Frequency (e.g., frequency in megahertz (MHz), gigahertz (GHz), etc.) is the processor operating frequency (which may be greater than or equal to the minimum processor operating frequency needed to meet the processing performance requirement); Workload is the number of instructions to be executed to perform an operation; and Processing_Performance is the processing performance of one or more processing units (in Million Instructions Per Second (MIPS), for example) based on processor architecture, type and/or number of processors.

With the minimum operating frequency determined, the electronic device 102 (e.g., processing performance mode determiner 120, 420) may determine the most efficient processing performance mode (e.g., operating frequency) that meets the processing performance requirement. For example, the electronic device 102 (e.g., processing performance mode determiner 120, 420) may determine the highest energy efficiency at an operating frequency that is greater than or equal to the minimum operating frequency (that corresponds to a processing performance mode, for instance). In some configurations, the electronic device 102 (e.g., processing performance mode determiner 120, 420) may request and/or receive a processing efficiency profile (e.g., energy efficiencies from a look up table) corresponding to each processing performance mode having an operating frequency that is greater than or equal to the minimum operating frequency. The electronic device 102 (e.g., processing performance mode determiner 120, 420) may determine (e.g., select) the processing performance mode with the highest processing efficiency with an operating frequency that is greater than or equal to the minimum operating frequency.

In one example with a larger time budget for client processing, assume that the minimum operating frequency for an operation is determined to be 750 MHz and the processing efficiency profile is given as the energy efficiencies corresponding to operating frequencies at or above 750 MHz for processor A 792a in graph B 784b. In this example, the processing performance mode determiner 120, 420 may select a processing performance mode that operates at 1300 MHz, at approximately the peak processing energy efficiency for processor A 792a. In another example with a smaller time budget for client processing, assume that the minimum operating frequency for an operation is determined to be 1500 MHz and the processing efficiency profile is given as the energy efficiencies corresponding to operating frequencies at or above 1500 MHz for processor A 792a in graph B 784b. In this example, the processing performance mode determiner 120, 420 may select a processing performance mode that operates at 1500 MHz, at the highest processing energy efficiency for processor A 792a at operating frequencies greater than or equal to 1500 MHz. As these examples illustrate, there may be different optimal performance levels depending on silicon characteristics, time budget and/or estimated energy efficiency.

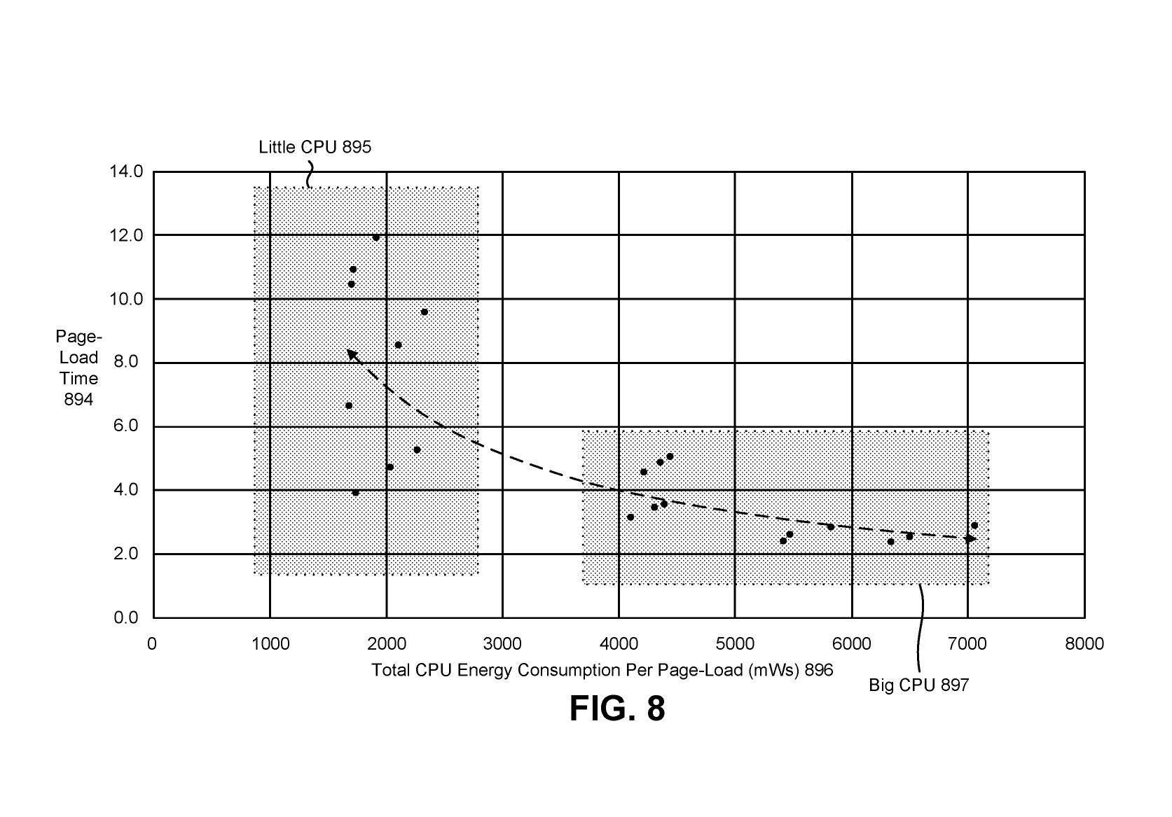

FIG. 8 includes a graph illustrating examples of page load times versus processor energy consumption for multiple processors (e.g., in a big.LITTLE CPU architecture). The graph is illustrated in page-load time 894 (seconds) over total CPU energy consumption per page-load 896 (milliwatt seconds (mWs)).

Some configurations of the systems and methods disclosed herein may be implemented in conjunction with a big.LITTLE CPU architecture. In the big.LITTLE CPU architecture, an electronic device 102 may include multiple processors. For example, one processor (e.g., the “big” CPU) may offer faster speeds at the cost of higher energy consumption, while another processor (e.g., the “LITTLE” CPU) may offer slower speeds with lower energy consumption. As illustrated in FIG. 8, the little CPU 895 may offer lower energy consumption, but long page load latency for a browser application, while the big CPU 897 provides short page-load latency, but higher energy consumption for the browser application. The systems and methods disclosed herein may be implemented to determine (e.g., to make an improved or optimal decision of) LITTLE CPUs or big CPUs for task scheduling, depending on the processing performance requirement (e.g., time budget) and processing efficiency (e.g., processing energy efficiency) as described herein. It should be noted that an inverse relationship may exist between web browsing page-download time to processor MIPS (Million Instructions per Second) and operating frequency (MHz). Processor MIPS may be proportional to processor operating frequency (e.g., MHz).

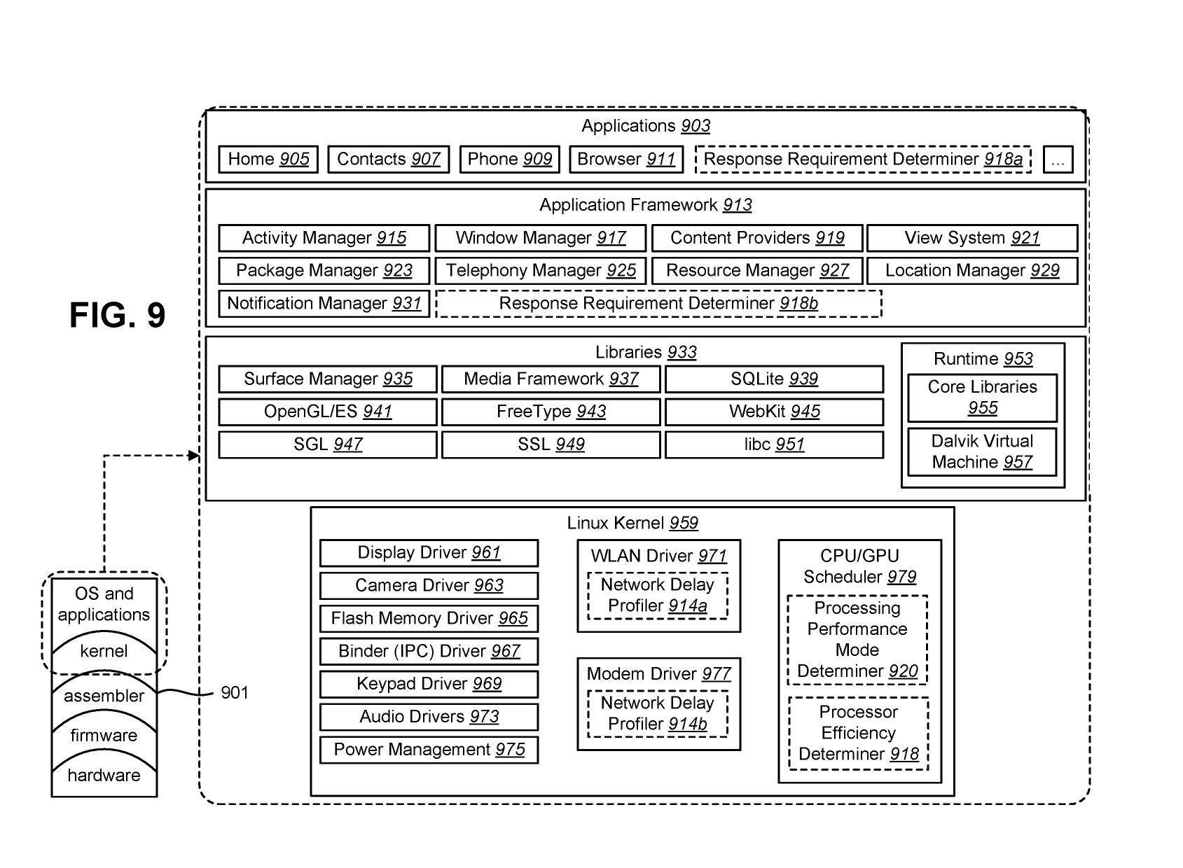

FIG. 9 is a block diagram illustrating an example of hierarchy layers in which systems and methods for controlling processing performance may be implemented. For example, FIG. 9 illustrates examples of hierarchy layers 901 (e.g., abstraction layers, software/firmware/hardware hierarchy layers) and examples of where one or more functions of the systems and methods disclosed herein may be implemented in some configurations. It should be noted that one or more functions may be implemented in one or more different layers 901 than illustrated in FIG. 9 in some configurations. The abstraction layers 901 may be implemented in the electronic device 102 (e.g., a smartphone) in some configurations. Some of the elements described in connection with FIG. 9 may be examples of corresponding elements described in connection with one or more of FIGS. 1 and 4.

Specifically, FIG. 9 illustrates applications 903, an application framework 913 and libraries 933, which may reside in the operating system (OS) and application layer of the abstraction layers 901. The applications 903 may be examples of the applications 130, 330 described in connection with one or more of FIGS. 1 and 3. FIG. 9 also illustrates a Linux kernel 959, which may reside in the kernel layer of the abstraction layers 901. It should be noted that the elements described in connection with FIG. 9 are merely examples. Fewer, additional and/or alternative elements may be implemented. Examples of applications 903 include a home application 905, contacts application 907, phone application 909, browser application 911 and/or one or more other applications. Examples of application framework 913 elements may include an activity manager 915, a package manager 923, a notification manager 931, a window manager 917, a telephony manager 925, content providers 919, a resource manager 927, a view system 921 and a location manager 929. As illustrated in FIG. 9, the response requirement determiner 918a-b (e.g., user experience analyzer) may be implemented in the applications 903 and/or application framework 913 of the OS and applications layer in some configurations.

Examples of libraries 933 may include a surface manager 935, a media framework 937, SQLite 939 (a Structured Query Language (SQL) database engine), OpenGL/ES 941 (OpenGL for Embedded Systems), FreeType 943 (a font engine), WebKit 945 (web browser engine), SGL 947 (Scalable Graphics Library), SSL 949 (Secure Sockets Layer), libc 951 (C library) and/or runtime 953 (e.g., Android runtime). The runtime 953 may include core libraries 955 and a Dalvik virtual machine 957.

Examples of elements in the Linux kernel 959 may include a display driver 961, a camera driver 963, a flash memory driver 965, a binder (inter-process communication (IPC)) driver 967, a keypad driver 969, audio drivers 973, power management 975, WLAN driver 971, modem driver 977 and/or a CPU and/or Graphics Processing Unit (GPU) scheduler 979. As illustrated in FIG. 9, the network delay profiler 914a-b (e.g., RTT profiler) may be implemented in the modem driver 977 and/or WLAN driver 971. Additionally or alternatively, the processing performance mode determiner 920 (e.g., algorithm to determine the processor and/or device performance mode) may be implemented in the CPU/GPU scheduler 979. Additionally or alternatively, the processor efficiency determiner 918 (e.g., simplified processor power model) may be implemented in the CPU/GPU scheduler 979 and/or drivers.

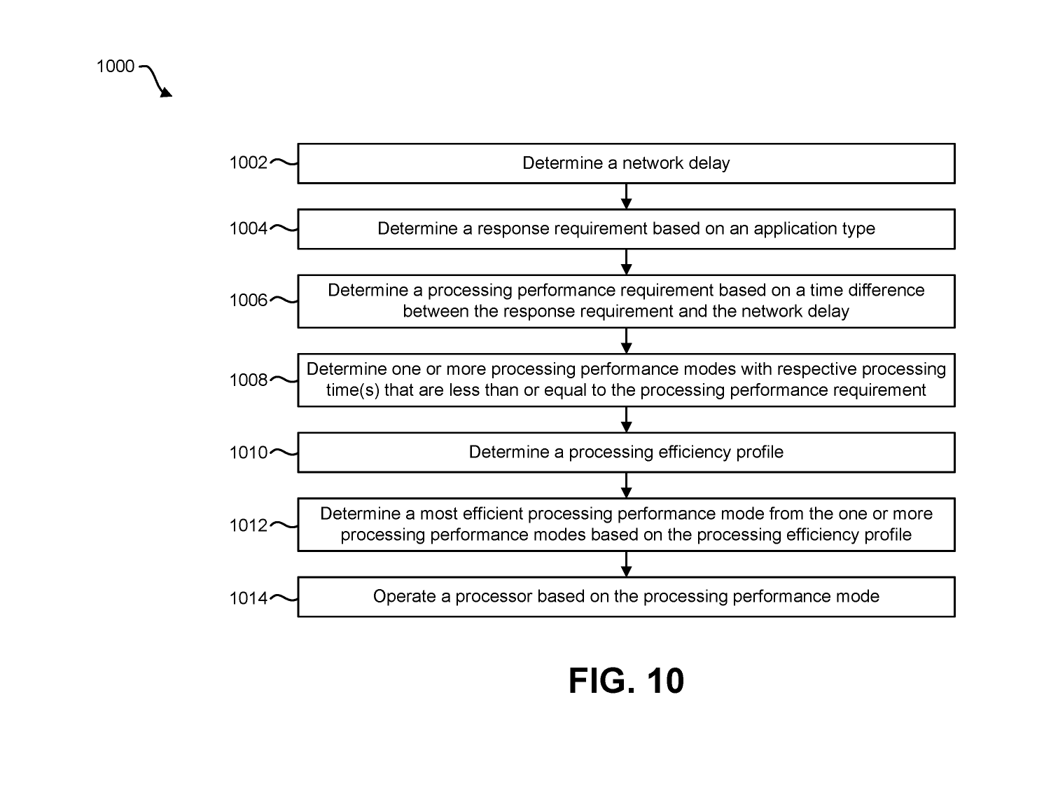

FIG. 10 is a flow diagram illustrating a more specific configuration of a method 1000 for controlling processor performance. The method 1000 may be performed by an electronic device (e.g., the electronic device 102 described in connection with FIG. 1).

The electronic device 102 may determine 1002 a network delay. This may be accomplished as described in connection with one or more of FIGS. 1-5 and 9. For example, the electronic device 102 may utilize one or more time metrics (e.g., send time(s), response time(s) and/or time stamp(s), etc.) to determine the network delay.

The electronic device 102 may determine 1004 a response requirement based on an application type. This may be accomplished as described in connection with one or more of FIGS. 1-2, 4-6 and 7-9. For example, the electronic device 102 may access (e.g., look up) and/or compute (e.g., analyze user behavior to determine) the response requirement corresponding to an application type (that is running, in use, for instance), specific application and/or data type.

The electronic device 102 may determine 1006 a processing performance requirement based on a time difference between the response requirement and the network delay. This may be accomplished as described in connection with one or more of FIGS. 1-2 and 4-9. For example, the electronic device 102 may subtract the network delay from the response requirement to determine the processing performance requirement.

The electronic device 102 may determine 1008 one or more processing performance modes with respective processing time(s) that are less than or equal to the processing performance requirement. This may be accomplished as described in connection with one or more of FIGS. 1-2 and 4-9. For example, the electronic device 102 may determine a minimum operating frequency as described in connection with FIG. 7 (e.g., Equation (2)) and may determine one or more processing performance modes with operating frequencies that are greater than or equal to the minimum operating frequency.

The electronic device 102 may determine 1010 a processing efficiency profile. This may be accomplished as described in connection with one or more of FIGS. 1-2, 4-5 and 7-9. For example, the electronic device 102 may determine and/or receive a processing efficiency profile (corresponding to one or more processor(s) 112, for instance). In some configurations, the electronic device 102 may determine 1010 one or more processing efficiencies (e.g., the processing efficiency profile, processing energy efficiencies, etc.) corresponding to the one or more processing performance modes with operating frequencies that are greater than or equal to the minimum operating frequency. For example, the processing efficiency determiner 116 may look up processing efficiencies corresponding to operating frequencies of the processing performance modes.

The electronic device 102 may determine 1012 a most efficient processing performance mode from the determined 1010 one or more processing performance modes based on the processing efficiency profile. This may be accomplished as described in connection with one or more of FIGS. 1-2 and 4-9. For example, the electronic device 102 may select a most efficient processing performance mode by selecting the processing performance mode with the highest processing efficiency (e.g., processing energy efficiency).

The electronic device 102 may operate 1014 a processor based on the processing performance mode. This may be accomplished as described in connection with one or more of FIGS. 1-2 and 4-9. For example, the electronic device 102 may set (e.g., adjust) one or more processors 112 to operate in accordance with the processing performance mode (e.g., operating frequency, DCVS, big.LITTLE processor scheduler, etc.).

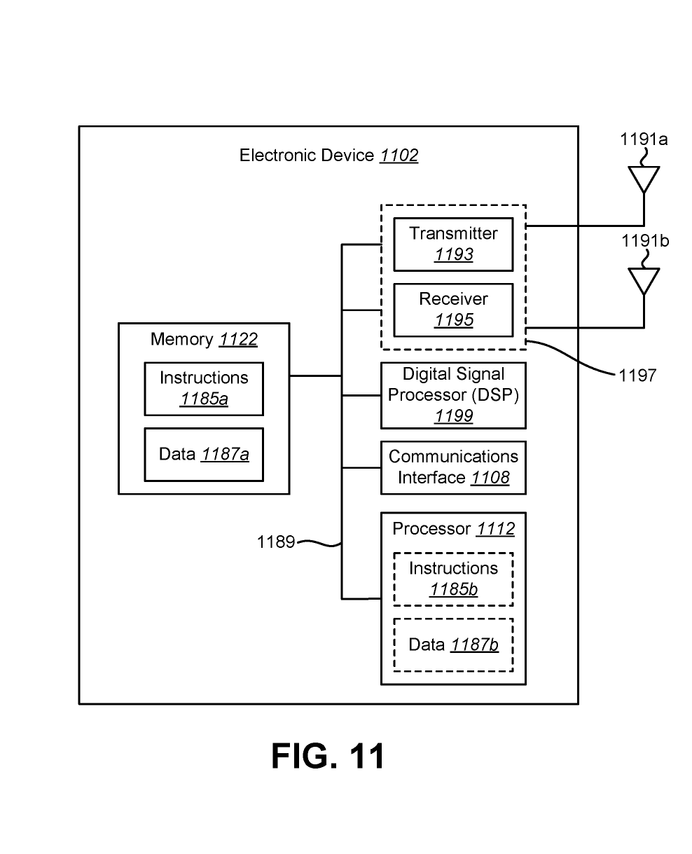

FIG. 11 illustrates certain components that may be included within an electronic device 1102 configured to implement various configurations of the systems and methods disclosed herein. The electronic device 1102 may be implemented in accordance with the electronic device 102 described herein. Examples of the electronic device 1102 may include an access terminal, a mobile station, a user equipment (UE), a smartphone, a digital camera, a video camera, a tablet device, a laptop computer, etc. The electronic device 1102 includes a processor 1112. The processor 1112 may be a general purpose single- or multi-chip microprocessor (e.g., an ARM), a special purpose microprocessor (e.g., a digital signal processor (DSP)), a microcontroller, a programmable gate array, etc. The processor 1112 may be referred to as a central processing unit (CPU). Although just a single processor 1112 is shown in the electronic device 1102, in an alternative configuration, a combination of processors (e.g., an ARM and DSP) could be implemented.

The electronic device 1102 also includes memory 1122. The memory 1122 may be any electronic component capable of storing electronic information. The memory 1122 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1187a and instructions 1185a may be stored in the memory 1122. The instructions 1185a may be executable by the processor 1112 to implement one or more of the methods described herein. Executing the instructions 1185a may involve the use of the data 1187a that is stored in the memory 1122. When the processor 1112 executes the instructions 1185, various portions of the instructions 1185b may be loaded onto the processor 1112, and/or various pieces of data 1187b may be loaded onto the processor 1112.

The electronic device 1102 may also include a transmitter 1193 and a receiver 1195 to allow transmission and reception of signals to and from the electronic device 1102. The transmitter 1193 and receiver 1195 may be collectively referred to as a transceiver 1197. One or more antennas 1191a-b may be electrically coupled to the transceiver 1197. The electronic device 1102 may also include (not shown) multiple transmitters, multiple receivers, multiple transceivers and/or additional antennas.

The electronic device 1102 may include a digital signal processor (DSP) 1199. The electronic device 1102 may also include a communications interface 1108. The communications interface 1108 may allow and/or enable one or more kinds of input and/or output. For example, the communications interface 1108 may include one or more ports and/or communication devices for linking other devices to the electronic device 1102. In some configurations, the communications interface 1108 may include the transmitter 1193, the receiver 1195, or both (e.g., the transceiver 1197). Additionally or alternatively, the communications interface 1108 may include one or more other interfaces (e.g., touchscreen, keypad, keyboard, microphone, camera, etc.). For example, the communications interface 1108 may enable a user to interact with the electronic device 1102.

The various components of the electronic device 1102 may be coupled together by one or more buses, which may include a power bus, a control signal bus, a status signal bus, a data bus, etc. For the sake of clarity, the various buses are illustrated in FIG. 11 as a bus system 1189.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for controlling processing performance by an electronic device, comprising:
determining a processing performance requirement based on a time difference between a response requirement based on an application type and a network delay;
determining a processing performance mode based on the processing performance requirement and a processing efficiency profile; and
operating a processor based on the processing performance mode.

2. The method of claim 1, further comprising determining the network delay by measuring a time between a request time and a response time.

3. The method of claim 1, wherein the network delay comprises a network transit time and a server processing time.

4. The method of claim 1, wherein determining the processing performance mode comprises:
determining one or more processing performance modes with one or more respective processing performance times that are less than or equal to the processing performance requirement; and
determining a most efficient processing performance mode of the one or more processing performance modes by selecting, from the one or more processing performance modes, a processing performance mode corresponding to a highest associated processing efficiency indicated by the processing efficiency profile.

5. The method of claim 1, wherein determining the processing performance mode comprises determining a minimum processor operating frequency that satisfies the processing performance requirement.

6. The method of claim 1, further comprising determining the processing efficiency profile by determining a set of processing energy efficiencies corresponding to a set of processing performance modes.

7. The method of claim 1, further comprising determining the response requirement by analyzing one or more usage metrics.

8. An electronic device for controlling processing performance, comprising:
a processor configured to:
determine a processing performance requirement based on a time difference between a response requirement based on an application type and a network delay;
determine a processing performance mode based on the processing performance requirement and a processing efficiency profile; and
operate the processor based on the processing performance mode.

9. The electronic device of claim 8, wherein the processor is configured to determine the network delay by measuring a time between a request time and a response time.

10. The electronic device of claim 8, wherein the network delay comprises a network transit time and a server processing time.

11. The electronic device of claim 8, wherein the processor is configured to determine the processing performance mode by:
determining one or more processing performance modes with one or more respective processing performance times that are less than or equal to the processing performance requirement; and
determining a most efficient processing performance mode of the one or more processing performance modes by selecting, from the one or more processing performance modes, a processing performance mode corresponding to a highest associated processing efficiency indicated by the processing efficiency profile.

12. The electronic device of claim 8, wherein the processor is configured to determine the processing performance mode by determining a minimum processor operating frequency that satisfies the processing performance requirement.

13. The electronic device of claim 8, wherein the processor is configured to determine the processing efficiency profile by determining a set of processing energy efficiencies corresponding to a set of processing performance modes.

14. The electronic device of claim 8, wherein the processor is configured to determine the response requirement by analyzing one or more usage metrics.

15. A computer-program product for controlling processing performance, comprising a non-transitory computer-readable medium having instructions thereon, the instructions comprising:
code for causing the electronic device to determine a processing performance requirement based on a time difference between a response requirement based on an application type and a network delay;
code for causing the electronic device to determine a processing performance mode based on the processing performance requirement and a processing efficiency profile; and
code for causing the electronic device to operate a processor based on the processing performance mode.

16. The computer-program product of claim 15, further comprising code for causing the electronic device to measure a time between a request time and a response time to determine the network delay.

17. The computer-program product of claim 15, wherein the network delay comprises a network transit time and a server processing time.

18. The computer-program product of claim 15, wherein the code for causing the electronic device to determine the processing performance mode comprises:
code for causing the electronic device to determine one or more processing performance modes with one or more respective processing performance times that are less than or equal to the processing performance requirement; and
code for causing the electronic device to determine a most efficient processing performance mode of the one or more processing performance modes by selecting, from the one or more processing performance modes, a processing performance mode corresponding to a highest associated processing efficiency indicated by the processing efficiency profile.

19. The computer-program product of claim 15, wherein the code for causing the electronic device to determine the processing performance mode comprises code for causing the electronic device to determine a minimum processor operating frequency that satisfies the processing performance requirement.

20. The computer-program product of claim 15, further comprising code for causing the electronic device to determine the processing efficiency profile by determining a set of processing energy efficiencies corresponding to a set of processing performance modes.
